(19) United States
(12) Patent Application Publication
(10) Pub. No.: US 2009/0310965 A1
(43) Pub. Date: Dec. 17, 2009

(54) Optical Transmission System and Device for Receiving an Optical Signal

(75) Inventors: Jean-Marc Merolla, Foucherans (FR); Johann Cussey, Miserey-Salines (FR); Frédéric Patois, Besançon (FR); Nicolas Pelloquin, Trebeurden (FR)

Correspondence Address: BRIGGS AND MORGAN P.A., 2200 IDS CENTER, 80 SOUTH 8TH ST, MINNEAPOLIS, MN, 55402, US

(73) Assignees: SMARTQUANTUM SA, Lannion (FR); CENTRE NATIONAL DE LA RECHERCHE SCIENTIFIQUE, Paris Cedex (FR); UNIVERSITE DE FRANCHE-COMTE, Besançon (FR)

(21) Appl. No.: 11/989,388

(22) PCT Filed: Jul. 13, 2006
(86) PCT No.: PCT/FR2006/001744

§ 371 Date: Jul. 17, 2009

(30) Foreign Application Priority Data
Jul. 27, 2005 (FR) 0508013

(51) Int. Cl. H04J 14/06; H04L 9/08

(52) U.S. Cl. 398/65; 380/283

(57) ABSTRACT

The invention concerns a device (100) for receiving an optical signal comprising at least one optical signal of angular frequency ω₀ modulated by an electrical signal of angular frequency Ω whose phase φ1 varies according to the value of at least data bit to be transmitted. The reception device (100) comprises a polarisation separator (105) for separating the modulated optical signal of angular frequency ω₀, into first and second optical signals of different polarisation, means (140, 102, 103, 104) of obtaining two electrical signals, means (110a) of modulating the first optical signal from the first electrical signal, means (110b) of modulating the second optical signal from the second electrical signal, and means (115) of combining the first modulated optical signal and the second modulated optical signal in order to form a recombined optical signal.

The present invention concerns an optical transmission system and a device for receiving an optical signal comprising at least one optical signal modulated by an electrical signal, the phase of which varies according to the value of at least one data bit to be transmitted.

The present invention more particularly finds an application in the field of the protection of information transfers and especially in the field of quantum cryptography.

In a cryptography system, the information is coded at the sender and decoded by the receiver by means of a predetermined algorithm known to the sender and receiver. The security of the system depends on the fact that the key used by the algorithm is known solely to the authorised sender and receiver.

Quantum cryptography makes it possible to distribute the key of the algorithm so as to guarantee that, if a third-party device picks up the signals conveying the key, the sender and receiver can determine whether the key has been picked up by the third-party device.

In quantum cryptography, two communicational channels are preferentially used by the sending device and receiving device. A first communication channel, known as the quantum channel, is used for the transmission, in the form of photons, of the quantum key. A second communication channel, known as the public channel, is used by the sender and receiver to exchange data to check whether the transmission of the key over the quantum channel has been distorted, picked up by a third-party device or not.

The transfer of the cryptographic key takes place conventionally in the following manner:

At the first step, the sending device transmits over the quantum channel a sequence of photons, choosing the quantum state of each photon randomly. The state of each photon is chosen according to a rule known to the sending and receiving devices. Some of the states chosen are non-orthogonal, thus to say it is not possible to differentiate them with certainty.

The receiving device chooses, randomly and independently of the one used by the sending device, one decision rule from at least two decision rules. If the receiving device uses the same decision rule as the sending device, the receiving device determines unequivocally the value of the bit transmitted. If the receiving device uses a decision rule that is not compatible with the state chosen by the sender or the decision rule chosen by the sender, the result obtained does not make it possible to determine the value of the bit transmitted. The probability of concluding at a bit 1 or a bit 0 is therefore equiprobable. The measurement is therefore inconclusive.

When the transmission of photons has ended, the receiving device discloses, through the public channel to the sending device, the decision rule for each photon received. The result of the measurement naturally remains secret. The sending and receiving devices by this method eliminate all the inconclusive results. Finally, they share a random sequence of bits that can be used as the cryptographic key.

Various quantum cryptography techniques have been proposed. Some use the polarisation state of the photon in order to code binary information, others a phase modulation. In the quantum cryptography using phase modulation, a first solution consists of introducing a phase difference carrying the information by introducing a difference in optical path between the various optical signals and between at least two optical signals separated in time. A second solution consists of introducing a phase difference carrying the information between at least two optical signals separated in the frequency domain. This phase difference is effected by periodically modulating an optical signal.

The aforementioned cryptography techniques are sensitive to the variations in polarisation relating principally to the medium used for transmitting the photons. The photon transmission medium is, for example and non-limitatively, the atmosphere or an optical fibre. These variations in polarisation are related to the environment of the medium such as for example the variations in temperature thereof.

The invention resolves the drawbacks of the prior art by proposing a reception device that is insensitive to variations in polarisation and thus allows the transmission of the key according to the quantum cryptography technique over long distances and/or with great reliability over time.

To this end, according to a first aspect, the invention proposes a device for receiving an optical signal comprising at least one optical signal of angular frequency ω₀ modulated by an electrical signal of angular frequency Ω whose phase φ1 varies according to the value of at least one data bit to be transmitted, characterised in that the reception device comprises:

a polarisation separator for separating the modulated optical signal of angular frequency ω₀ into first and second optical signals propagating in the same direction, the first optical signal having a first polarisation and the second optical signal having a second polarisation,

means of obtaining first and second electrical signals of angular frequency Ω and of phase φ2,

means of modulating the first optical signal from the first electrical signal of angular frequency Ω and phase φ2,

means of modulating the second optical signal from the second electrical signal of angular frequency Ω and phase φ2,

means of combining the first modulated optical signal and the second modulated optical signal in order to form a recombined optical signal.

The invention also concerns a system for transmitting an optical signal comprising at least one optical signal of angular frequency ω₀ modulated by an electrical signal of angular frequency Ω whose phase φ1 varies according to the value of at least one data bit to be transmitted, characterised in that the system comprises:

a sending device able to form the optical signal of angular frequency ω₀ modulated by the electrical signal of angular frequency Ω whose phase φ1 varies according to the value of at least one data bit to be transmitted,

a receiving device comprising:

a polarisation separator for separating the modulated optical signal ω₀ into first and second optical signals propagating in the same direction, the first optical signal having a first polarisation and the second optical signal having a second polarisation,

means of obtaining first and second electrical signals of angular frequency Ω and of phase φ2,

means of modulating the first optical signal using the first electrical signal of angular frequency Ω and of phase φ2,

means of modulating the second optical signal using the second electrical signal of angular frequency Ω and of phase φ2,

means of combining the first modulated optical signal and a second modulated optical signal in order to form a recombined optical signal.

Thus a recombined optical signal is obtained that is insensitive to variations in polarisation. This insensitivity thus allows the transmission of data over long distances and/or of great reliability over time.

According to another aspect of the invention, the receiving device also comprises means of detecting photons included in the optical signal, means of counting the number of photons detected over a predetermined interval of time and means of transferring data to the sending device for modification of the angular frequency ω₀ of the optical signal.

Thus the reception device is insensitive to variations in frequency of the optical signals relating for example to temperature or variations over time.

According to another aspect of the invention, the means of modulating the first optical signal and second optical signal are phase modulators or intensity modulators or electro-absorbent modulators.

According to another aspect of the invention, the amplitude and/or phase of the first and second optical signals are adjusted independently.

Thus dispersions with regard to the active and/or or passive components are eliminated.

According to another aspect of the invention, the data are a cryptographic key and the optical signal consists of at least one modulation sideband comprising a photon.

Thus it is possible to transmit a cryptographic key over long distances.

According to another aspect of the invention, the optical signal also comprises an optical signal of angular frequency ωₛ modulated by the electrical signal of angular frequency Ω and the means of obtaining the electrical signal of angular frequency Ω and of phase φ2 comprise:

a wavelength demultiplexer (140) that separates in the optical signal the modulated optical signal of angular frequency ω₀ from the optical signal of angular frequency ωₛ,

a detector that detects the photons of the modulated optical signal of angular frequency ωₛ in order to form a synchronisation electrical signal of angular frequency Ω,

a phase shifter for the synchronisation electrical signal of phase φ2.

Thus the reception device has a synchronisation signal that is insensitive to the variations relating to the variations in the optical path of the optical signal received.

According to another aspect of the invention, the device also comprises at least one filter for forming an optical signal whose angular frequency corresponds to the angular frequency of one of the modulation sidebands issuing from the modulation of the optical signal of angular frequency ω₀ and at least one detector for detecting at least one photon in the optical signal comprising the modulation sideband.

Thus the cost and size of the reception device are reduced.

According to another aspect of the invention, the filter is a Fabry-Pérot cavity and the device also comprises means of modifying the characteristics of the Fabry-Pérot cavity.

Thus it is possible to adjust the characteristics of the Fabry-Pérot cavity.

According to another aspect of the invention, the optical signal consists of two modulation sidebands and the means of modifying the characteristics of the Fabry-Pérot cavity modify the characteristics of the Fabry-Pérot cavity in order to form an optical signal comprising one or other of the modulation sidebands.

Thus it is possible to choose the modulation sideband that is used for detecting the cryptographic key. It is then more difficult for a spy device to detect the cryptographic key without the reception device and/or the sending device that sent the optical signal detecting it.

According to another aspect of the invention, the means of modifying the characteristics of the Fabry-Pérot cavity modify the characteristics of the Fabry-Pérot cavity according to the number of photons detected over a predetermined interval of time.

Thus the reception device is insensitive to variations in frequency of the optical signals relating for example to the temperature or to variations over time.

According to another aspect of the invention, the Fabry-Pérot cavity is associated with a temperature regulation device and the means of modifying the characteristics of the Fabry-Pérot cavity comprise means of modifying the regulation temperature.

Thus the characteristics of the Fabry-Pérot cavity are modified in a simple manner.

The characteristics of the invention mentioned above, as well as others, will emerge more clearly from a reading of the following description of an example embodiment, the said description being given in relation to the accompanying drawings, among which:

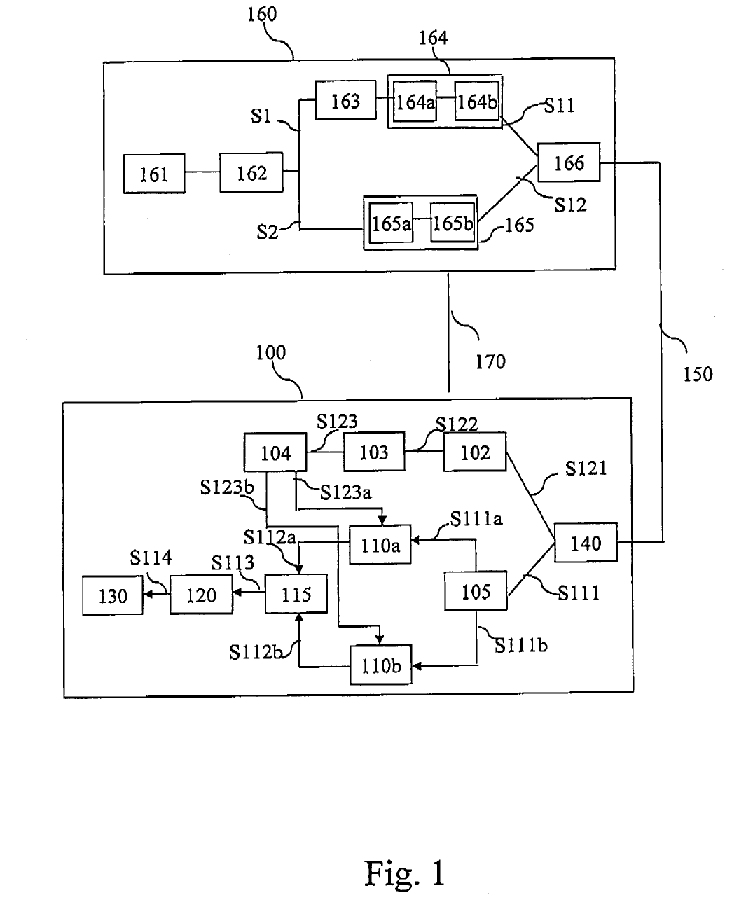

FIG. 1 depicts the architecture of the optical transmission system according to the present invention;

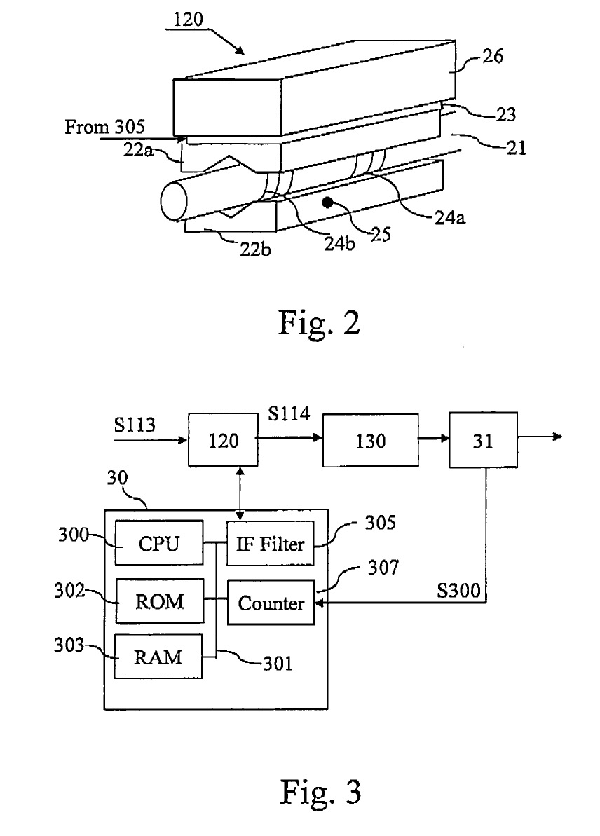

FIG. 2 depicts a Fabry-Pérot cavity according to the present invention;

FIG. 3 depicts a system for controlling the temperature of the Fabry-Pérot cavity according to the present invention.

FIG. 1 depicts the architecture of the optical transmission system according to the present invention.

The optical transmission system as depicted in FIG. 1 is particularly adapted to the transmission of a cryptographic key.

In the system for the secure optical transmission of a cryptographic key, a sending device 160 transmits, by means of a transmission medium 150, a cryptographic key to a reception device 100.

The transmission medium 150 is a quantum channel and is for example an optical fibre. The transmission medium 150 can also, according to a variant embodiment, be the atmosphere.

The emission device 160 is also connected to the receiving device 100 by means of a public channel 170. The public channel 170 is for example included in a public communication network such as for example a network of the IP type or a communication network of the telephonic type. By means of the public channel 170, the sending device 160 and the receiving device 100 exchange information for exchanging a key as previously described.

The sending device 160 comprises a sinusoidal oscillator 161 of angular frequency Ω. The sinusoidal electrical signal delivered by the oscillator 161 is then separated into two signals S1 and S2 by a power divider 162 or “power splitter” in English. The signals S1 and S2 are preferably of the same amplitude.

The signal S1 is then phase-shifted by a phase shifting circuit 163. The phase shifting of the signal S1 makes it possible to code the information bits to be transmitted. According to the value of the information bit to be transmitted, the phase difference φ1 is equal to 0 or π/2 when the B92 two-state protocol is used or is equal to 0 or π/2, π or 3 π/2 when the BB84 protocol is used. The BB84 protocol is described in the publication by C H Bennett and G Brassard entitled “Quantum cryptography: Public key distribution and coin tossing”, Proceedings of IEEE International on Computers, Systems and Signal Processing, Bangalore, India (IEEE New York 1984) pp 175-179.

The B92 protocol is described in the publication by C H Bennett entitled “Quantum cryptography using two non-orthogonal states”, Physical Review Letters, Vol 68, No 21, pp 3121-3124, 1992.

The out-of-phase electrical signal S1 is then transferred to a source 164 emitting an optical signal, which modulates the optical signal of angular frequency ω₀ by the out-of-phase signal S1. The source 164 sending an optical signal consists, for example and non-limitatively, of a laser diode 164a and an electro-optical modulator 164b integrated on a lithium niobate (LiNbO₃) crystal substrate or an electro-absorption modulator preferably integrated on the chip of the laser diode 164a. The source 164 emitting the optical signal modulates the optical signal by the out-of-phase signal S1 with a modulation factor denoted m₁ that is preferentially very much less than unity. It should be noted here that, the intensity phase modulation ratio of the laser diode 164 being negligible, the optical signal S1 formed by the emission source 164 is approximated as follows:

$${E}_{11} ( t ) = \sqrt{\frac{{I}_{0}}{2}} [ 1 + \frac{{m}_{1}}{2} cos ( Ω t + {φ}_{1} ) ] exp ( j {ω}_{0} t )$$

$${E}_{11} ( t ) = {E}_{0} [ 1 + \frac{{m}_{1}}{2} cos ( Ω t + {φ}_{1} ) ] exp ( j {ω}_{0} t )$$

in which E₀ is the peak amplitude of the signal E₁₁(t)

The spectral power density of the signal E₁₁(t) consists of a frequency carrying line at ω₀/2π, a frequency modulation sideband at (ω₀+Ω)/2π, and a frequency modulation sideband at (ω₀−Ω)/2π.

In a variant embodiment of the present invention, the laser diode 164a is a DFB diode, the acronym for “distributed feedback”, the angular frequency ω₀ of which is modified, for example by means of a change in its operating temperature, according to an instruction received from the reception device 100 by means of the transmission medium 150 or the public channel 170.

The electrical signal S2 is transferred to a source 165 sending an optical signal that modulates the optical signal of angular frequency ωₛ different from the angular frequency ω₀ by the signal S2 in order to form a synchronisation signal S2. The source 165 sending an optical signal consists, for example and non-limitatively, of a laser diode 165a and an electro-optical modulator 165b integrated on a lithium niobate (LiNbO₃) crystal substrate or an electro-absorption modulator preferably integrated on the chip of the laser diode.

The optical signals S11 and S12 are then multiplexed by a wavelength multiplexer 166 and sent over the quantum channel 150.

It should be noted here that, in a first variant embodiment, the sending device 160 does not have any power splitter 162, sending source 165 and wavelength multiplexer 166. According to this variant embodiment, only the signal S11 is formed and transferred over the quantum channel 150.

It should be noted here that, prior to the sending of the optical signal over the quantum channel, it is attenuated so that the probability of having more than one photon in each modulation sideband is low. Typically the probably of having a one photon per modulation sideband is less than 0.01 for each pulse.

The reception device 100 comprises a wavelength demultiplexer 140 that separates, in the received signal, the optical signal S111 or quantum signal S111 from the optical signal S121 or reference signal S121.

It should be noted here that the reference signal S121 avoids having, at the reception device 100, a local oscillator synchronised on the signal of angular frequency Ω of the sending device 160.

The reference signal S121 of angular frequency ωₛ is transferred to a detector 102, such as for example an avalanche photodiode.

The detector 102 produces an electrical signal S122 with the same angular frequency Ω as the signal delivered by the oscillator 161 of the sending device 160.

It should be noted that, according to the first variant embodiment, instead of obtaining the electrical signal S122 of angular frequency Ω of the optical signal received, the receiving device 100 comprises a local oscillator of angular frequency Ω as well as means of synchronising its local oscillator with the local oscillator 161 of the sending device 160.

The electrical signal S122 is then phase-shifted by a phase-shifting circuit 103. The phase-shifting circuit 103 shifts the electrical signal S122 by a phase difference φ2+π/2. The phase difference φ2 is equal to 0 or π/2 when the B92 two-state protocol is used or is equal to 0 or π/2, n or 3 π/2 when the BB84 protocol is used.

The out-of-phase electrical signal S123 is then separated into two electrical signals S123a and S123b with the same amplitude by a power splitter 104. The phases and amplitudes of the electrical signals S123a and S123b are adjusted so as to equalise the variations in amplitude in phase relating to the characteristics of the active element such as amplifiers (not shown in FIG. 1) or passive elements such as the length of the tracks conveying the electrical signals S123a and S123b, so as to obtain a modulation factor m₂ at the phase modulators 110a and 110b equal to a m₁/2.

The electrical signals S123a and S123b are used as modulation signals respectively by the modulators 110a and 110b.

The quantum signal S111 is, according to the invention, transferred to a polarisation separator 105. The polarisation separation 105 separates the received quantum signal S111 of any polarisation into two optical signals S111a and S111b propagating in the same direction but according to different polarisations. These polarisations are preferably orthogonal.

The electrical field of the quantum signal received S111 is shown in an orthogonal reference frame, the axes \vec{u} and \vec{v} of which are the axes of the polarisation separator 105 in the form:

$$\vec{{E}_{S 111}} ∝ {E}_{0} [ A ( 1 + \frac{{m}_{1}}{2} cos ( Ω t + {φ}_{1} ) ) \vec{u} + B ( 1 + \frac{{m}_{1}}{2 } cos ( Ω t + {φ}_{1} ) ) \vec{v} ]$$

in which A and B are the respective projections of the electrical field \vec{E}_{S111} on the axes \vec{u} and \vec{v}.

It should be noted here that A and B satisfy the following equation: A²+B²=1.

Thus the quantum signal S111 is divided into an optical signal S111a or quantum signal S111a, the electrical field of which is:

$$\vec{{E}_{S 111 a}} ∝ {E}_{0} A ( 1 + \frac{{m}_{1}}{2} cos ( Ω t + {φ}_{1} ) )$$

and into an optical signal S111b or a quantum signal S111b whose electrical field is:

$$\vec{{E}_{S 111 b}} ∝ {E}_{0} B ( 1 + \frac{{m}_{1}}{2} cos ( Ω t + {φ}_{1} ) ) .$$

The polarisation separator 105 is, for example and non-limitatively, a polarisation separator sold by the company General Photonics Corporation under the name “Polarization Beam Splitter PBS-001-P-03-SM-FC/PC”.

The quantum signals S111a and S111b are respectively transmitted to a phase modulator 110a and to a phase modulator 110b. In a variant, the modulators 110a and 110b are intensity modulators or electro-absorbent modulators.

The modulator 110a modulates the quantum signal S111a by the electrical signal S123a, the phase modulator 110b modulates the quantum signal S111b by the electrical signal S123b.

The modulators 110 are modulators for example marketed by the company “EOspace” under the name “Very-Low-Loss Phase Modulator”.

When the sending device 160 and the reception device 100 are in phase, that is to say φ1 is equal to φ2, the modulation sideband of angular frequency ω₀+Ω is maximum and the modulation sideband of angular frequency ω₀−Ω is zero.

On the other hand, if the sending device 160 and the reception device 100 are in phase opposition, the modulation sideband of angular frequency ω₀−Ω is maximum and the modulation sideband of angular frequency ω₀+Ω is zero.

The intensity of the quantum signal S112a in the band of angular frequency ω₀±Ω at the output of the phase modulator 110a is proportional to:

i_{ω}_{_{0±Ω}}^{S112a} ∝ A²(1±cos(φ1−φ2))

The intensity of the quantum signal S112b in the band of angular frequency ω₀±Ω at the output of the phase modulator 110b is proportional to:

i_{ω}_{_{0±Ω}}^{S112b} ∝ B²(1±cos(φ1−φ2))

The quantum signals S112a and S112b are then recombined by a polarisation separator 115, identical to the polarisation separator 105 and used inversely.

After recombination, the total intensity of the band of angular frequency ω₀±Ω of the quantum signals S112a and S112b is proportional to:

i_{ω}_{_{0±Ω}}^{tot} ∝ (A²+B²)(1±cos(φ1−φ2))

and by simplification to

i_{ω}_{_{0±Ω}}^{tot} ∝ (1±cos(φ1−φ2))

It is noted here that the total intensity depends neither on A nor B and therefore on the polarisation of the received quantum signal S111. The receiver thus formed is thus insensitive to polarisation.

The recombined signal S113 is filtered by a filter 120 in order to form a signal S114, which comprises solely one of the two modulation sidebands. The filter 120 consists of Bragg filters, multilayer filters, AWG filters, the acronym for Array Wave Guide, etc. Preferentially, the filter 120 is a Fabry-Pérot cavity. It will be described in more detail with regard to FIG. 2.

The recombined signal S113 consists of three frequencies: the frequency at ω₀/2π, a modulation sideband of frequency (ω₀−Ω)/2π and a modulation sideband of frequency (ω₀+Ω)/2π. The filter 120 filters the recombined signal S113 so as to eliminate the component at the frequency ω₀/2π and one of the modulation sidebands, for example the sideband at the frequency (ω₀−Ω)/2π.

The signal S114 is then processed by a quantum detector 130 consisting of a photodetector that detects each photon transmitted in the sideband of frequency (Ω₀+Ω)/2π.

It should be noted here that, in a second variant embodiment, the receiving device 100 comprises two filters that filter the recombined signal S113 so as to obtain respectively a first optical signal comprising the sideband at the frequency (ω₀−Ω)/2π and a second optical signal comprising the sideband at the frequency (ω₀+Ω)/2π. According to this second variant embodiment, the first optical signal is then processed by a first photodetector that detects each photon transmitted in the sideband of frequency (ω₀−Ω)/2π and the second optical signal is then processed by a second optical detector that detects each photon transmitted in the sideband of frequency (ω₀−Ω)/2π.

FIG. 2 depicts a Fabry-Pérot cavity according to the present invention.

The Fabry-Pérot cavity 120 consists of two Bragg mirrors 24a and 24b inscribed on an optical fibre 21 consisting for example of a 9 μm core and a 125 μm sheath. The cavity thus formed is held in a support composed of two parts 22a and 22b. The two parts 22a and 22b are presented distant from each other in FIG. 2 so as to allow representation of the optical fibre 21. In reality, the parts 22a and 22b are in contact to allow good thermal conduction. A temperature regulation module 23 such as for example a Peltier-effect module 23 is placed on the top part of the support 22a to enable the optical fibre 21 to be heated or cooled. A thermal dissipater 26 is placed on the Peltier-effect module 23 and makes it possible to optimise the temperature difference that exists between the external environment and the temperature of the Fabry-Pérot cavity 120. A temperature sensor 25, for example a thermistor, is placed on the bottom part 22b of the support and makes it possible to determine the temperature of the optical fibre 21.

In the Fabry-Pérot cavity 120, the centre wavelength of the Bragg mirrors 24 corresponding to the maximum reflection is variable as a function of the temperature. According to the invention, a system controlling the temperature of the Fabry-Pérot cavity is implemented so as to adjust the frequency band or frequency bands filtered by the Fabry-Pérot cavity 120.

According to a variant embodiment of the present invention, the Fabry-Pérot cavity 120 is not controlled for temperature in order to adjust the frequency band or frequency bands filtered according to the number of photons detected in a predetermined interval of time. According to this variant, the angular frequency ω₀ of the laser diode 164a is controlled so that one of the two modulation bands lies in the frequency band or frequency bands filtered by the Fabry-Pérot cavity 120.

FIG. 3 depicts a system for controlling the temperature of the Fabry-Pérot cavity according to the present invention.

The recomposed signal S113 is filtered by the Fabry-Pérot cavity 120 described previously. The resulting signal S114 consists of a single frequency and contains on average less than one photon. The quantum detector 130 is preferentially a cooled avalanche photodiode. The avalanche photodiode functions in active triggering and/or with feedback triggering. It should be noted here that the quantum detector comprises as a variant means of transposing the frequency of the resulting signal S114 into a double frequency, so as to increase the performance of the quantum detector.

The quantum detector 130 detects the passage of a photon. When the passage of a photon is detected, the quantum detector 130 emits an electrical pulse that is shaped by an adaptation circuit 31 so as to be processed subsequently by conventional digital electronic components. The adapted signal S300 is transferred to a processing unit 30. The processing unit 30 is for example a microprocessor or DSP, the acronym for “Digital Signal Processor”, or a computer.

The processing unit 30 comprises a communication bus 301 to which there are connected a processor 300, a non-volatile memory 302, a random access memory 303, a filter interface 305 and a counter 307.

The processing unit 30 also comprises a communication interface, not shown in FIG. 3, which allows for transfer of data affording control of the angular frequency ω₀ of the diode 120.

A non-volatile memory 302 stores the frequency slaving program of the filter according to the present invention. When the processing unit 30 is powered up, the programs are transferred into the random access memory 303, which then contains the executable code of the invention as well as the data necessary for implementing the invention.

The pulses of the adapted signal S300 are counted by the counter 307 for a predetermined time from around a few microseconds to a few seconds. The predetermined time is defined amongst other things according to the efficiency of the detector and the attenuation of the transmission channel.

The processor 300 obtains the number of pulses counted by the counter 306. When the filter 120 is not tuned to the frequency (ω₀−Ω)/2π, the number of pulses counted decreases. The processor 300 determines, from a predetermined formula or a lookup table stored in the non-volatile memory 302, the electrical signal that must be delivered to the Peltier effect module 23 so as to modify the temperature of the optical fibre 21 and therefore to adjust the frequency band or frequency bands filtered by the Fabry-Pérot cavity 120. If the number of pulses detected decreases when the value of the instruction increases, then the direction of variation of the instruction is reversed. Otherwise the value of the instruction varies in the same direction until a reduction in the number of beats detected is once again observed.

In a variant embodiment, the processor 300 determines, from a predetermined formula or a lookup table stored in the non-volatile memory 302, data that are transmitted to the sending device 160 so as to modify the angular frequency ω₀ of the laser diode 120 so that one of the two modulation bands is included in the frequency band or frequency bands filtered by the Fabry-Pérot cavity 120.

The processor 300 transfers the electrical signal determined to the filter interface 305, which delivers the electrical signal corresponding to the Peltier effect module 23. The temperature change makes it possible to shift the frequency characteristics of the Fabry-Pérot cavity 120 and to correct the drifts in wavelength of the filter or sinusoidal oscillator 161 of the sending device 160.

According to the variant embodiment, the processor 300 transfers the data determined to the sending device 160 by means of the communication interface and the transmission medium 150 or the public channel 170.

The filter interface 305 is able to receive the electrical signal delivered by the thermistor 25 in order to check whether the temperature of the optical fibre 21 is in accordance with the regulation temperature and to correct the variations in wavelength or transmission frequency of the sending source 164.

In the same way, the processor 300 is able to transfer an electrical signal to the Peltier-effect module so as to bring the temperature of the optical fibre 21 to two different set temperatures. These set temperatures modify characteristics of the Fabry-Pérot cavity 120 in order to obtain an optical signal S114 comprising one or other of the modulation sidebands. This makes it possible to choose the modulation sideband.

The processor 300 is also able to process the pulses of the adapted signal 300 in order to use these for negotiating the encrypting key and to transfer it to a decrypting and/or encrypting device or any subsequent processing.

Naturally the present invention is in no way limited to the embodiments described here but quite the contrary encompasses any variant within the capability of a person skilled in the art.

1. Device (100) for receiving an optical signal comprising at least one optical signal of angular frequency ω₀ modulated by an electrical signal of angular frequency Ω whose phase φ1 varies according to the value of at least one data bit to be transmitted, characterised in that the reception device (100) comprises:
a polarisation separator (105) for separating the modulated optical signal (S111) of angular frequency ω₀ into first (S111a) and second (S111b) optical signals propagating in the same direction, the first optical signal (S111a) having a first polarisation and the second optical signal (S111b) having a second polarisation,
means (140, 102, 103, 104) of obtaining first and second electrical signals of angular frequency Ω and phase φ2,
means (110a) of modulating the first optical signal from the first electrical signal of angular frequency Ω and phase φ2,
means (110b) of modulating the second optical signal from the second electrical signal of angular frequency Ω and phase φ2,
means (115) of combining the first modulated optical signal and the second modulated optical signal in order to form a recombined optical signal.

2. Device according to claim 1, characterised in that the means of modulating the first optical signal and second optical signal are phase modulators or intensity modulators or electro-absorbent modulators.

3. Device according to claim 1, characterised in that the amplitude and/or the phase of the first and second optical signals are adjusted independently.

4. Device according to claim 1, characterised in that the data are a cryptographic key and in that the optical signal consists of at least one modulation sideband comprising a photon.

5. Device according to claim 4, characterised in that the optical signal also comprises an optical signal (S121) of angular frequency ωₛ modulated by the electrical signal of angular frequency Ω and in that the means of obtaining the electrical signal of angular frequency Ω and of phase φ2 comprise:
a wavelength demultiplexer (140) that separates in the optical signal the modulated optical signal of angular frequency ω₀ from the optical signal of angular frequency ωₛ,
detector (102) that detects the photons of the modulated optical signal of angular frequency ωₛ in order to form a synchronisation electrical signal of angular frequency Ω,
a phase shifter (103) for the synchronisation electrical signal of phase φ2.

6. Device according to claim 5, characterised in that the device also comprises at least one filter (120) for forming an optical signal whose angular frequency corresponds to the angular frequency of one of the modulation sidebands issuing from the modulation of the optical signal of angular frequency ω₀ and at least at one detector (130) for detecting at least one photon in the optical signal comprising the modulation sideband.

7. Device according to claim 6, characterised in that the filter is a Fabry-Pérot cavity and in that the device also comprises means (30) of modifying the characteristics of the Fabry-Pérot cavity.

8. Device according to claim 7, characterised in that the optical signal consist of two modulation sidebands and in that the means of modifying the characteristics of the Fabry-Pérot cavity modify the characteristics of the Fabry-Pérot cavity in order to form an optical signal comprising one or other of the modulation sidebands.

9. Device according to claim 7, characterised in that the means of modifying the characteristics of the Fabry-Pérot cavity modify the characteristics of the Fabry-Pérot cavity according to the number of photons detected over a predetermined interval of time.

10. Device according to claim 7, characterised in that the Fabry-Pérot cavity is associated with a temperature regulation device and in that the means of modifying the characteristics of the Fabry-Pérot cavity comprise means of modifying the regulation temperature.

11. System for transmitting an optical signal comprising at least one optical signal of angular frequency ω₀ modulated by an electrical signal of angular frequency Ω whose phase φ1 varies according to the value of at least one data bit to be transmitted, characterised in that the system comprises:
a sending device (160) able to form the optical signal of angular frequency ω₀ modulated by the electrical signal of angular frequency Ω whose phase φ1 varies according to the value of at least one data bit to be transmitted,
a receiving device (100) comprising:
a polarisation separator (105) for separating the modulated optical signal ω₀ into first and second optical signals propagating in the same direction, the first optical signal having a first polarisation and the second optical signal having a second polarisation,
means (140, 102, 103, 104) of obtaining first and second electrical signals of angular frequency Ω and phase φ2,
means (110a) of modulating the first optical signal from the first electrical signal of angular frequency Ω and phase φ2,
means (110b) of modulating the second optical signal from the second electrical signal of angular frequency Ω and phase φ2,
means (115) of combining the first modulated optical signal and the second modulated optical signal in order to form a recombined optical signal.

12. System according to claim 11, characterised in that the receiving device also comprises means of detecting photons included in the optical signal, means of counting the number of photons detected over a predetermined interval of time and means of transferring data to the sending device for modifying the angular frequency ω₀ of the optical signal.
